(19) United States
(12) Patent Application Publication
(10) Pub. No.: US 2020/0273142 A1
(43) Pub. Date: Aug. 27, 2020

(54) BIN RESOLVE WITH CONCURRENT RENDERING OF A NEXT BIN

(71) Applicant: QUALCOMM Incorporated, San Diego, CA (US)

(72) Inventors: Shambhoo Khandelwal, Santa Clara, CA (US); Tao Wang, Sunnyvale, CA (US); Shangmei Yu, Sunnyvale, CA (US); Jing Gao, San Jose, CA (US); Jian Liang, San Diego, CA (US); Andrew Evan Gruber, Arlington, MA (US); Chun Yu, Rancho Santa Fe, CA (US)

(21) Appl. No.: 16/282,003

(22) Filed: Feb. 21, 2019

(51) Int. Cl. G06T 1/60; G06F 3/06

(52) U.S. Cl. CPC G06T 1/60; G06F 3/0604; G06F 3/065; G06F 3/0673; G06F 3/0659

(57) ABSTRACT

The described techniques provide for bin-based rendering where the scene geometry in a frame is subdivided into bins or tiles, and bins are resolved concurrently with the rendering of a next bin. For example, a graphics processing unit (GPU) may process an entire image and sort transactions (e.g., rasterized primitives, such as triangles) into bins. For the rendering of each transaction, a device may identify a memory address of a memory block (e.g., a unit or portion of internal GPU memory (GMEM)) the transaction will be written (i.e., rendered) to. The device may thus prepare the memory block for rendering (e.g., by performing a resolve operation, a clear operation, or an unresolve operation on the memory block), such that the memory block is prepared prior to rendering of the particular transaction. As such, transactions of a bin may be resolved concurrently with rendering of transactions of a next bin.

### BACKGROUND

The following relates generally to image processing at a device, and more specifically to bin resolve with concurrent rendering of a next bin.

A device that provides content for visual presentation on an electronic display may include a graphics processing unit (GPU). The GPU, in conjunction with other components, renders pixels that are representative of the content on the display. That is, the GPU may generate one or more pixel values for each pixel on the display and perform graphics processing on the pixel values for each pixel on the display to render each pixel for presentation.

A GPU may convert two-dimensional or three-dimensional virtual objects into a two-dimensional pixel representation that may be displayed. Converting information about three-dimensional objects into a bitmap that can be displayed is known as pixel rendering, and may require considerable memory and processing power. For example, a screen or display may be divided into a number of bins, where each bin may be processed sequentially.

Each bin may be rendered to a GPU internal memory (GMEM) and then resolved from the GMEM to a frame buffer in system memory. The GPU may rasterize one or more primitives that correspond to each bin (e.g., or each three-dimensional graphics object) in order to generate a plurality of pixels that correspond to each bin. Each bin rendered GMEM may then be resolved sequentially. In some cases, as all or the majority of the GMEM bandwidth may be used for storage of rendered pixel depth and/or color information associated with a bin, the bin may be resolved prior to rendering of a next bin to prevent undesirable overwriting of pixel information in GMEM (e.g., prior to copying over bin information to the system memory).

As such, devices (e.g., personal computers, smartphones, tablet computers, etc.) may use a GPU for rendering of graphics data for display. In some cases, such devices may have constraints on graphics rendering time, computational power, memory capacity, and/or other parameters. Improved render and resolve techniques may be thus be desired.

### SUMMARY

The described techniques relate to improved methods, systems, devices, or apparatuses that support bin resolve with concurrent rendering of a next bin. Generally, the described techniques provide for transaction-based rendering in which the scene geometry in a frame is subdivided into bins or tiles, and transactions (e.g., of a bin) are resolved concurrently with the rendering of a next transaction (e.g., of a next bin). For example, a graphics processing unit (GPU) may process an entire image and sort transactions (e.g., rasterized primitives, such as triangles) into bins. In some cases, the GPU may process a command stream for an entire image and assign the rasterized primitives of the image to bins. For the rendering of each transaction, a device may identify a memory address of a memory block (e.g., a unit or portion of internal GPU memory (GMEM) corresponding to the memory address) the transaction will be written (i.e., rendered) to. The device may then prepare the memory block for rendering (e.g., by performing one or more of a resolve operation, a clear operation, or an unresolve operation on the memory block), such that the memory block is resolved prior to rendering of the particular transaction. As such, transactions of a bin may be resolved concurrently with rendering of transactions of a next bin. That is, a device may identify a memory address, that a transaction will be rendered to, early in a GPU pipeline (e.g., based on pixel address (X, Y) information), such that a memory block of the internal memory (e.g., a unit or portion of the GMEM corresponding to the memory address) may be resolved, cleared, unresolved, etc. while the transaction is being rendered (e.g., while depth and color information of the transaction is being identified or processed).

A method of image processing at a device is described. The method may include identifying memory location information corresponding to a first transaction associated with a first bin of a frame and performing, based on the identified memory location information, one or more of a resolve operation, a clear operation, an unresolve operation, or a tag compare operation. The method may further include identifying depth and color information of the first transaction, where the resolve operation, the clear operation, the unresolve operation, or the tag compare operation is performed concurrently with the identifying of the depth and color information of the first transaction. The method may further include writing the depth and color information of the first transaction based on the resolve operation, the clear operation, the unresolve operation, or the tag compare operation.

An apparatus for image processing at a device is described. The apparatus may include a processor, memory in electronic communication with the processor, and instructions stored in the memory. The instructions may be executable by the processor to cause the apparatus to identify memory location information corresponding to a first transaction associated with a first bin of a frame, perform, based on the identified memory location information, one or more of a resolve operation, a clear operation, an unresolve operation, or a tag compare operation, identify depth and color information of the first transaction, where the resolve operation, the clear operation, the unresolve operation, or the tag compare operation is performed concurrently with the identifying of the depth and color information of the first transaction, and write the depth and color information of the first transaction based on the resolve operation, the clear operation, the unresolve operation, or the tag compare operation.

Another apparatus for image processing at a device is described. The apparatus may include means for identifying memory location information corresponding to a first transaction associated with a first bin of a frame, performing, based on the identified memory location information, one or more of a resolve operation, a clear operation, an unresolve operation, or a tag compare operation, identifying depth and color information of the first transaction, where the resolve operation, the clear operation, the unresolve operation, or the tag compare operation is performed concurrently with the identifying of the depth and color information of the first transaction, and writing the depth and color information of the first transaction based on the resolve operation, the clear operation, the unresolve operation, or the tag compare operation.

A non-transitory computer-readable medium storing code for image processing at a device is described. The code may include instructions executable by a processor to identify memory location information corresponding to a first transaction associated with a first bin of a frame, perform, based on the identified memory location information, one or more of a resolve operation, a clear operation, an unresolve operation, or a tag compare operation, identify depth and color information of the first transaction, where the resolve operation, the clear operation, the unresolve operation, or the tag compare operation is performed concurrently with the identifying of the depth and color information of the first transaction, and write the depth and color information of the first transaction based on the resolve operation, the clear operation, the unresolve operation, or the tag compare operation.

In some examples of the method, apparatuses, and non-transitory computer-readable medium described herein, the identifying the memory location information includes identifying a memory address corresponding to the first transaction. Some examples of the method, apparatuses, and non-transitory computer-readable medium described herein may further include operations, features, means, or instructions for resolving a memory block to a frame buffer in system memory, where the depth and color information of the first transaction may be written to the memory block based on the resolve operation, the clear operation, or the unresolve operation.

Some examples of the method, apparatuses, and non-transitory computer-readable medium described herein may further include operations, features, means, or instructions for updating a transaction resolve priority based on the identified memory address, where the resolve operation, the clear operation, or the unresolve operation may be performed based on the updated transaction resolve priority. Some examples of the method, apparatuses, and non-transitory computer-readable medium described herein may further include operations, features, means, or instructions for identifying pixel coordinates of the first transaction from a graphic processing unit pipeline, where the memory address may be identified based on the identified pixel coordinates.

In some examples of the method, apparatuses, and non-transitory computer-readable medium described herein, the performing on the memory block, based on the identified memory address, one or more of a resolve operation, a clear operation, or an unresolve operation includes performing the resolve operation, the clear operation, or the unresolve operation on a second transaction associated with a second bin of the frame based on the identified memory address, where the second bin precedes the first bin.

In some examples of the method, apparatuses, and non-transitory computer-readable medium described herein, the performing the resolve operation on the second transaction includes copying depth and color information of the second transaction from the memory block to the frame buffer in system memory, where the depth and color information of the first transaction may be identified concurrently with the copying. In some examples of the method, apparatuses, and non-transitory computer-readable medium described herein, the performing the clear operation on the second transaction includes writing an initializing value to the memory block based on the identified memory address, where the depth and color information of the first transaction may be identified concurrently with the writing. In some examples of the method, apparatuses, and non-transitory computer-readable medium described herein, performing the unresolve operation on the second transaction may include operations, features, means, or instructions for copying data from the frame buffer in system memory to the memory block based on the identified memory address, where the depth and color information of the first transaction may be identified concurrently with the copying.

In some examples of the method, apparatuses, and non-transitory computer-readable medium described herein, the depth and color information of the first transaction may be written to the memory block based on the identified memory address.

Some examples of the method, apparatuses, and non-transitory computer-readable medium described herein may further include operations, features, means, or instructions for identifying a second transaction associated with a second bin of the frame, and identifying the memory address corresponds to the second transaction, where the memory block may be resolved based on the identified memory address. Some examples of the method, apparatuses, and non-transitory computer-readable medium described herein may further include operations, features, means, or instructions for identifying depth and color information of the second transaction, where the memory block may be resolved concurrently with the identifying of the depth and color information of the second transaction.

In some examples of the method, apparatuses, and non-transitory computer-readable medium described herein, the identifying the memory location information includes identifying a cache line index, a tag indicating a presence of a memory address for each cache line corresponding to the cache line index, or both.

### BRIEF DESCRIPTION OF THE DRAWINGS

FIG. 1 illustrates an example of a device that supports bin resolve with concurrent rendering of a next bin in accordance with aspects of the present disclosure.

FIG. 2 illustrates an example of a binning layout that supports bin resolve with concurrent rendering of a next bin in accordance with aspects of the present disclosure.

FIGS. 3A, 3B, and 3C illustrate example processing timelines that support bin resolve with concurrent rendering of a next bin in accordance with aspects of the present disclosure.

FIG. 4 illustrates an example of a graphics processing unit (GPU) processing pipeline that supports bin resolve with concurrent rendering of a next bin in accordance with aspects of the present disclosure.

FIGS. 5 and 6 show block diagrams of devices that support bin resolve with concurrent rendering of a next bin in accordance with aspects of the present disclosure.

FIG. 7 shows a block diagram of a GPU that supports bin resolve with concurrent rendering of a next bin in accordance with aspects of the present disclosure.

FIG. 8 shows a diagram of a system including a device that supports bin resolve with concurrent rendering of a next bin in accordance with aspects of the present disclosure.

FIGS. 9-11 show flowcharts illustrating methods that support bin resolve with concurrent rendering of a next bin in accordance with aspects of the present disclosure.

### DETAILED DESCRIPTION

Some graphics processing unit (GPU) architectures may require a relatively large amount of data to be read from and written to system memory when rendering a frame of graphics data (e.g., an image). Mobile architectures (e.g., GPUs on mobile devices) may lack the memory bandwidth capacity required for processing entire frames of data. Accordingly, bin-based architectures may be utilized to divide an image into multiple bins (e.g., tiles). The bins may be sized so that they can be processed using a relatively small amount (e.g., 256 kilobytes (kB)) of high bandwidth, on-chip graphics memory (which may be referred to as a cache, a GPU memory, or a graphics memory (GMEM) in aspects of the present disclosure). That is, the size of each bin may depend on or be limited by the size of the cache (e.g., the size of the GMEM). The image may then be reconstructed after processing each bin.

Bin rendering may thus be described with respect to a number of processing passes. For example, when performing bin-based rendering, a GPU may perform a binning pass and a plurality of rendering passes. With respect to the binning pass, the GPU may process an entire image and sort transactions (e.g., rasterized primitives, such as lines or triangles) into bins. For example, the GPU may process a command stream for an entire image and assign the rasterized primitives of the image to bins. Each bin may then be rendered and resolved. In render phase, pixel depth and/or color values may be rendered to memory storage internal to GPU (e.g., GMEM). The GMEM may store the depth and/or color values of every pixel or sample in the bin. The values may be updated throughout the rendering phase. Once rendering is finished, a resolve phase may begin. In the resolve phase, data is copied from GMEM to a frame buffer in system memory. A device may thus aggregate data or information for each bin (e.g., stored in system memory), and display the graphics data.

In some cases, all or most of the GMEM may be used to store color and/or depth information of one bin (e.g., a device may establish a bin size based on the capacity of the GMEM). As such, render and resolve may occur sequentially, such that resolve of the bin finishes before the render of the next bin starts (e.g., to prevent overwriting the pixel value in GMEM before it is copied over to system memory). A graphic display time may thus depend on the number of bins, a bin render time, and subsequent bin resolve time. In some applications (e.g., such as gaming applications), resolve phase may be responsible for, for example, 10% of graphic display time and may be bound by system memory bandwidth. Additionally, render phase may be GPU bound and system memory bandwidth may be under-utilized.

The described techniques may provide for concurrent render and resolve (e.g., resolving of a first bin in parallel with rendering of a second bin). For example, during a rendering phase, a device may use excess system memory bandwidth to concurrently resolve a previous bin, such that a memory block (e.g., a unit or portion of the GMEM) is available for the rendering. That is, from a double data rate (DDR) bandwidth point of view, the resolve time (e.g., the 10% resolve phase contribution to graphic display time) may be consumed during the DDR idle time of rendering (e.g., in parallel with rendering passes), thus reducing the total graphic display time. The described techniques may thus reduce graphic display time (e.g., graphic processing latency) without increasing the size of the GMEM.

For example, the GMEM may be divided into several memory blocks, where each memory block is associated with a memory address and is large enough to store depth and color information for a transaction of a bin. For the rendering of each transaction, a device may identify a memory address of a memory block where the transaction will be rendered at an early stage of the GPU processing pipeline (e.g., after rasterization), such that the memory block may be resolved, cleared, unresolved, etc. while the transaction is being rendered. For example, an upstream processing block (e.g., a low depth resolution block) may receive a transaction (e.g., pixels) before those pixel are to be read written in GMEM. The upstream block may pass the pixel information to a concurrent resolve engine (CRE), where the CRE may identify a memory address corresponding to the memory block the pixel information will ultimately be rendered (e.g., written) to. The CRE may then resolve, clear, unresolve, etc. the memory block in parallel with the remainder of the rendering of the transaction (e.g., such that the rendered depth and color information of the transaction may then be written to the memory block without overwriting information that has not yet been resolved).

In general, a device may identify a memory address corresponding to a transaction in a rendering phase, and may update a transaction resolve priority such that the portion of the GMEM corresponding to the memory address is resolved, cleared, or unresolved, earlier. The device may thus resolve, clear, or unresolve the memory block while depth and/or color information of the transaction in the rendering pass is identified. Such concurrent render and resolve techniques may reduce graphic display time (e.g., graphic processing latency) compared to sequential render and resolve techniques, which may increase the number of frames per second a device is capable of. Further the described techniques may be implemented without additional memory bandwidth.

Aspects of the disclosure are initially described in the context of a computing device, a binning layout, and example processing timelines. Aspects of the disclosure are further illustrated by and described with reference to apparatus diagrams, system diagrams, and flowcharts that relate to bin resolve with concurrent rendering of a next bin.

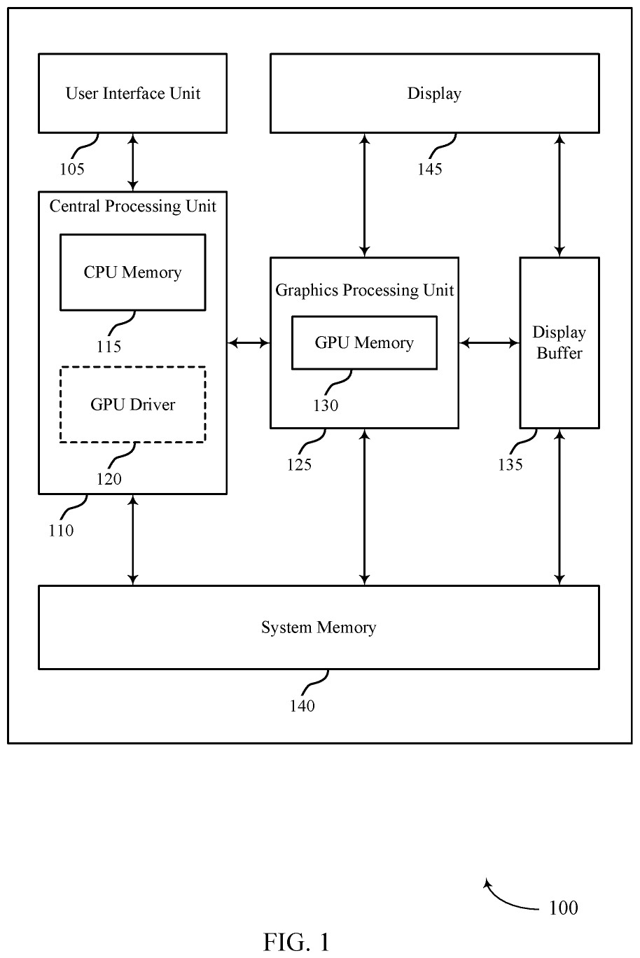

FIG. 1 illustrates an example of a device 100 in accordance with various aspects of the present disclosure. Examples of device 100 include, but are not limited to, wireless devices, mobile or cellular telephones, including smartphones, personal digital assistants (PDAs), video gaming consoles that include video displays, mobile video gaming devices, mobile video conferencing units, laptop computers, desktop computers, televisions set-top boxes, tablet computing devices, e-book readers, fixed or mobile media players, and the like.

In the example of FIG. 1, device 100 includes a central processing unit (CPU) 110 having CPU memory 115, a GPU 125 having GPU memory 130, a display 145, a display buffer 135 storing data associated with rendering, a user interface unit 105, and a system memory 140. For example, system memory 140 may store a GPU driver 120 (illustrated as being contained within CPU 110 as described below) having a compiler, a GPU program, a locally-compiled GPU program, and the like. User interface unit 105, CPU 110, GPU 125, system memory 140, and display 145 may communicate with each other (e.g., using a system bus).

Examples of CPU 110 include, but are not limited to, a digital signal processor (DSP), general purpose microprocessor, application specific integrated circuit (ASIC), field programmable logic array (FPGA), or other equivalent integrated or discrete logic circuitry. Although CPU 110 and GPU 125 are illustrated as separate units in the example of FIG. 1, in some examples, CPU 110 and GPU 125 may be integrated into a single unit. CPU 110 may execute one or more software applications. Examples of the applications may include operating systems, word processors, web browsers, e-mail applications, spreadsheets, video games, audio and/or video capture, playback or editing applications, or other such applications that initiate the generation of image data to be presented via display 145. As illustrated, CPU 110 may include CPU memory 115. For example, CPU memory 115 may represent on-chip storage or memory used in executing machine or object code. CPU memory 115 may include one or more volatile or non-volatile memories or storage devices, such as flash memory, a magnetic data media, an optical storage media, etc. CPU 110 may be able to read values from or write values to CPU memory 115 more quickly than reading values from or writing values to system memory 140, which may be accessed, e.g., over a system bus.

GPU 125 may represent one or more dedicated processors for performing graphical operations. That is, for example, GPU 125 may be a dedicated hardware unit having fixed function and programmable components for rendering graphics and executing GPU applications. GPU 125 may also include a DSP, a general purpose microprocessor, an ASIC, an FPGA, or other equivalent integrated or discrete logic circuitry. GPU 125 may be built with a highly-parallel structure that provides more efficient processing of complex graphic-related operations than CPU 110. For example, GPU 125 may include a plurality of processing elements that are configured to operate on multiple vertices or pixels in a parallel manner. The highly parallel nature of GPU 125 may allow GPU 125 to generate graphic images (e.g., graphical user interfaces and two-dimensional or three-dimensional graphics scenes) for display 145 more quickly than CPU 110.

GPU 125 may, in some instances, be integrated into a motherboard of device 100. In other instances, GPU 125 may be present on a graphics card that is installed in a port in the motherboard of device 100 or may be otherwise incorporated within a peripheral device configured to interoperate with device 100. As illustrated, GPU 125 may include GPU memory 130. For example, GPU memory 130 may represent on-chip storage or memory used in executing machine or object code. GPU memory 130 may include one or more volatile or non-volatile memories or storage devices, such as flash memory, a magnetic data media, an optical storage media, etc. GPU 125 may be able to read values from or write values to GPU memory 130 more quickly than reading values from or writing values to system memory 140, which may be accessed, e.g., over a system bus. That is, GPU 125 may read data from and write data to GPU memory 130 without using the system bus to access off-chip memory. This operation may allow GPU 125 to operate in a more efficient manner by reducing the need for GPU 125 to read and write data via the system bus, which may experience heavy bus traffic.

Display 145 represents a unit capable of displaying video, images, text or any other type of data for consumption by a viewer. Display 145 may include a liquid-crystal display (LCD), a light emitting diode (LED) display, an organic LED (OLED), an active-matrix OLED (AMOLED), or the like. Display buffer 135 represents a memory or storage device dedicated to storing data for presentation of imagery, such as computer-generated graphics, still images, video frames, or the like for display 145. Display buffer 135 may represent a two-dimensional buffer that includes a plurality of storage locations. The number of storage locations within display buffer 135 may, in some cases, generally correspond to the number of pixels to be displayed on display 145. For example, if display 145 is configured to include 640×480 pixels, display buffer 135 may include 640×480 storage locations storing pixel color and intensity information, such as red, green, and blue pixel values, or other color values. Display buffer 135 may store the final pixel values for each of the pixels processed by GPU 125. Display 145 may retrieve the final pixel values from display buffer 135 and display the final image based on the pixel values stored in display buffer 135.

User interface unit 105 represents a unit with which a user may interact with or otherwise interface to communicate with other units of device 100, such as CPU 110. Examples of user interface unit 105 include, but are not limited to, a trackball, a mouse, a keyboard, and other types of input devices. User interface unit 105 may also be, or include, a touch screen and the touch screen may be incorporated as part of display 145.

System memory 140 may comprise one or more computer-readable storage media. Examples of system memory 140 include, but are not limited to, a random access memory (RAM), static RAM (SRAM), dynamic RAM (DRAM), a read-only memory (ROM), an electrically erasable programmable read-only memory (EEPROM), a compact disc read-only memory (CD-ROM) or other optical disc storage, magnetic disc storage, or other magnetic storage devices, flash memory, or any other medium that can be used to store desired program code in the form of instructions or data structures and that can be accessed by a computer or a processor. System memory 140 may store program modules and/or instructions that are accessible for execution by CPU 110. Additionally, system memory 140 may store user applications and application surface data associated with the applications. System memory 140 may in some cases store information for use by and/or information generated by other components of device 100. For example, system memory 140 may act as a device memory for GPU 125 and may store data to be operated on by GPU 125 as well as data resulting from operations performed by GPU 125

In some examples, system memory 140 may include instructions that cause CPU 110 or GPU 125 to perform the functions ascribed to CPU 110 or GPU 125 in aspects of the present disclosure. System memory 140 may, in some examples, be considered as a non-transitory storage medium. The term “non-transitory” should not be interpreted to mean that system memory 140 is non-movable. As one example, system memory 140 may be removed from device 100 and moved to another device. As another example, a system memory substantially similar to system memory 140 may be inserted into device 100. In certain examples, a non-transitory storage medium may store data that can, over time, change (e.g., in RAM).

System memory 140 may store a GPU driver 120 and compiler, a GPU program, and a locally-compiled GPU program. The GPU driver 120 may represent a computer program or executable code that provides an interface to access GPU 125. CPU 110 may execute the GPU driver 120 or portions thereof to interface with GPU 125 and, for this reason, GPU driver 120 is shown in the example of FIG. 1 within CPU 110. GPU driver 120 may be accessible to programs or other executables executed by CPU 110, including the GPU program stored in system memory 140. Thus, when one of the software applications executing on CPU 110 requires graphics processing, CPU 110 may provide graphics commands and graphics data to GPU 125 for rendering to display 145 (e.g., via GPU driver 120).

In some cases, the GPU program may include code written in a high level (HL) programming language, e.g., using an application programming interface (API). Examples of APIs include Open Graphics Library (“OpenGL”), DirectX, Render-Man, WebGL, or any other public or proprietary standard graphics API. The instructions may also conform to so-called heterogeneous computing libraries, such as Open-Computing Language (“OpenCL”), DirectCompute, etc. In general, an API includes a predetermined, standardized set of commands that are executed by associated hardware. API commands allow a user to instruct hardware components of a GPU 125 to execute commands without user knowledge as to the specifics of the hardware components. In order to process the graphics rendering instructions, CPU 110 may issue one or more rendering commands to GPU 125 (e.g., through GPU driver 120) to cause GPU 125 to perform some or all of the rendering of the graphics data. In some examples, the graphics data to be rendered may include a list of graphics primitives (e.g., points, lines, triangles, quadrilaterals, etc.).

The GPU program stored in system memory 140 may invoke or otherwise include one or more functions provided by GPU driver 120. CPU 110 generally executes the program in which the GPU program is embedded and, upon encountering the GPU program, passes the GPU program to GPU driver 120. CPU 110 executes GPU driver 120 in this context to process the GPU program. That is, for example, GPU driver 120 may process the GPU program by compiling the GPU program into object or machine code executable by GPU 125. This object code may be referred to as a locally-compiled GPU program. In some examples, a compiler associated with GPU driver 120 may operate in real-time or near-real-time to compile the GPU program during the execution of the program in which the GPU program is embedded. For example, the compiler generally represents a unit that reduces HL instructions defined in accordance with a HL programming language to low-level (LL) instructions of a LL programming language. After compilation, these LL instructions are capable of being executed by specific types of processors or other types of hardware, such as FPGAs, ASICs, and the like (including, but not limited to, CPU 110 and GPU 125).

In the example of FIG. 1, the compiler may receive the GPU program from CPU 110 when executing HL code that includes the GPU program. That is, a software application being executed by CPU 110 may invoke GPU driver 120 (e.g., via a graphics API) to issue one or more commands to GPU 125 for rendering one or more graphics primitives into displayable graphics images. The compiler may compile the GPU program to generate the locally-compiled GPU program that conforms to a LL programming language. The compiler may then output the locally-compiled GPU program that includes the LL instructions. In some examples, the LL instructions may be provided to GPU 125 in the form a list of drawing primitives (e.g., triangles, rectangles, etc.).

The LL instructions (e.g., which may alternatively be referred to as primitive definitions) may include vertex specifications that specify one or more vertices associated with the primitives to be rendered. The vertex specifications may include positional coordinates for each vertex and, in some instances, other attributes associated with the vertex, such as color coordinates, normal vectors, and texture coordinates. The primitive definitions may include primitive type information, scaling information, rotation information, and the like. Based on the instructions issued by the software application (e.g., the program in which the GPU program is embedded), GPU driver 120 may formulate one or more commands that specify one or more operations for GPU 125 to perform in order to render the primitive. When GPU 125 receives a command from CPU 110, it may decode the command and configure one or more processing elements to perform the specified operation and may output the rendered data to display buffer 135.

GPU 125 generally receives the locally-compiled GPU program, and then, in some instances, GPU 125 renders one or more images and outputs the rendered images to display buffer 135. For example, GPU 125 may generate a number of primitives to be displayed at display 145. Primitives may include one or more of a line (including curves, splines, etc.), a point, a circle, an ellipse, a polygon (e.g., a triangle), or any other two-dimensional primitive. The term “primitive” may also refer to three-dimensional primitives, such as cubes, cylinders, sphere, cone, pyramid, torus, or the like. Generally, the term “primitive” refers to any basic geometric shape or element capable of being rendered by GPU 125 for display as an image (or frame in the context of video data) via display 145. GPU 125 may transform primitives and other attributes (e.g., that define a color, texture, lighting, camera configuration, or other aspect) of the primitives into a so-called “world space” by applying one or more model transforms (which may also be specified in the state data). Once transformed, GPU 125 may apply a view transform for the active camera (which again may also be specified in the state data defining the camera) to transform the coordinates of the primitives and lights into the camera or eye space. GPU 125 may also perform vertex shading to render the appearance of the primitives in view of any active lights. GPU 125 may perform vertex shading in one or more of the above model, world, or view space.

Once the primitives are shaded, GPU 125 may perform projections to project the image into a canonical view volume. After transforming the model from the eye space to the canonical view volume, GPU 125 may perform clipping to remove any primitives that do not at least partially reside within the canonical view volume. That is, GPU 125 may remove any primitives that are not within the frame of the camera. GPU 125 may then map the coordinates of the primitives from the view volume to the screen space, effectively reducing the three-dimensional coordinates of the primitives to the two-dimensional coordinates of the screen. Given the transformed and projected vertices defining the primitives with their associated shading data, GPU 125 may then rasterize the primitives. Generally, rasterization may refer to the task of taking an image described in a vector graphics format and converting it to a raster image (e.g., a pixelated image) for output on a video display or for storage in a bitmap file format.

A GPU 125 may include a dedicated fast bin buffer (e.g., a fast memory buffer, such as GMEM, which may be referred to by GPU memory 130). As discussed herein, a rendering surface may be divided into bins. In some cases, the bin size is determined by format (e.g., pixel color and depth information) and render target resolution divided by the total amount of GMEM. The number of bins may vary based on device 100 hardware, target resolution size, and target display format. A rendering pass may draw (e.g., render, write, etc.) pixels into GMEM (e.g., with a high bandwidth that matches the capabilities of the GPU). The GPU 125 may then resolve the GMEM (e.g., burst write blended pixel values from the GMEM, as a single layer, to a display buffer 135 or a frame buffer in system memory 140). Such may be referred to as bin-based or tile-based rendering. When all bins are complete, the driver may swap buffers and start the binning process again for a next frame.

For example, GPU 125 may implement a tile-based architecture that renders an image or rendering target by breaking the image into multiple portions, referred to as tiles or bins. The bins may be sized based on the size of GPU memory 130 (e.g., which may alternatively be referred to herein as GMEM or a cache), the resolution of display 145, the color or Z precision of the render target, etc. When implementing tile-based rendering, GPU 125 may perform a binning pass and one or more rendering passes. For example, with respect to the binning pass, GPU 125 may process an entire image and sort rasterized primitives into bins. GPU 125 may also generate one or more visibility streams during the binning pass, which visibility streams may be separated according to bin. For example, each bin may be assigned a corresponding portion of the visibility stream for the image. GPU driver 120 may access the visibility stream and generate command streams for rendering each bin. In some cases, a binning pass may alternatively be referred to as a visibility stream operation.

In some cases, with respect to each rendering pass, GPU 125 may perform a load operation, a rendering operation, and a store operation. During the load operation, GPU 125 may initialize GPU memory 130 for a new bin to be rendered. During the rendering operation, GPU 125 may render the bin and store the rendered bin to GPU memory 130. That is, GPU 125 may perform pixel shading and other operations to determine pixel values for each pixel of the tile and write the pixel values to GPU memory 130. During the store operation, GPU 125 may transfer the finished pixel values of the bin from GPU memory 130 to display buffer 135 or system memory 140. After GPU 125 has rendered all of the bins associated with a frame (e.g., or a given rendering target) in this way, display buffer 135 may output the finished image to display 145. As discussed above, such sequential bin rendering and bin resolve may, in some cases, result in additional graphic display time (e.g., due to dependence on sequential bin render time and subsequent bin resolve time).

In accordance with the described techniques, bin resolve, bin clear, and/or bin unresolve operations may be performed concurrently with rendering of a next bin. For example, with respect to each rendering pass, GPU 125 may perform a load operation, a rendering operation, and a store operation on a transactional basis. During the load operation, GPU 125 may initialize a memory block of GPU memory 130 for a new transaction to be rendered. During the rendering operation, GPU 125 may render the transaction and store the rendered transaction to the memory block in GPU memory 130. That is, GPU 125 may perform pixel shading and other operations to determine pixel values for one or more pixels associated with the transaction (e.g., depth and color information of the transaction) while performing bin resolve, bin clear, and/or bin unresolve operations in parallel. Therefore, the GPU 125 may prepare the memory block (e.g., perform a bin resolve operation, a bin clear operation, and/or a bin unresolve operation on the memory block) while the GPU 125 renders the transaction (e.g., identifies depth and color information of the transaction). The GPU 125 may then write the depth and color information to the memory block of the GPU memory 130. As such, the GPU 125 may begin rendering of a next bin without waiting for a bin resolve, bin clear, and/or bin unresolve operation being performed for the GPU memory 130 as a whole (e.g., as a next bin may be rendered while a previous bin is concurrently resolved, on a transactional basis, the device 100 may not need to wait for resolve of a bin before beginning rendering of a next bin). After GPU 125 has rendered all of the bins associated with a frame (e.g., or a given rendering target) in this way, system memory 140 and/or display buffer 135 may output the finished image to display 145.

For example, device 100 (e.g., GPU 125) may process an entire image and sort rasterized primitives (e.g., transactions) into bins. The GPU 125 may then render transactions of a first bin, and proceed to render transactions of a second bin while concurrently performing resolve operations, clear operations, and unresolve operations (e.g., associated with the first bin) on memory blocks of the GPU memory 130. For example, GPU 125 may identify a memory address corresponding to a transaction of a second bin (e.g., at some early stage of the GPU processing pipeline) and may perform a resolve operation, a clear operation, or an unresolve operation on a memory block corresponding to the memory address, while the GPU 125 continues to render the transaction in parallel (e.g., concurrently). That is, the GPU 125 may identify depth and color information of the transaction while the resolve operation, the clear operation, or the unresolve operation is performed concurrently with the identifying of the depth and color information. As such, information (e.g., depth and color information of transactions in a previously rendered bin) may be efficiently resolved, cleared, unresolved, etc., such that the depth and color information of the transaction being currently rendered may be written to the memory block of the GPU memory 130. After GPU 125 has rendered all of the bins associated with a frame (e.g., or a given rendering target) in this way, display buffer 135 and/or system memory 140 may output the finished image to display 145.

In some cases, an upstream processing block (e.g., some early processing stage in a GPU rendering pipeline, such as a low depth resolution block) may receive a transaction (e.g., pixels) and may pass some pixel information (e.g., pixel address (X, Y) information) to a CRE. The CRE may identify a memory address corresponding to the memory block (or location in GPU memory 130) that the pixel information will ultimately be rendered (e.g., written) to. The CRE may then resolve, clear, unresolve, etc. the memory block in parallel with the remainder of the rendering of the transaction (e.g., concurrently with the identification of the depth and color information of the transaction being rendered).

A resolve operation may refer to an operation where data or information (e.g., finished pixel values of a transaction) is copied (e.g., or transferred) from GPU memory 130 (e.g., GMEM) to system memory 140 (e.g., or in some cases display buffer 135). A clear operation may refer to an operation where the GPU memory 130 is initialized (e.g., some initial value is written to the GPU memory 130). For example, information rendered or written to a particular memory block of GMEM may be resolved and then cleared (e.g., concurrently with a next rendering pass of a transaction associated with a memory address corresponding to the memory block), such that the next rendering pass may then overwrite the cleared memory block (e.g., following identification of depth and color information of the transaction being rendered). An unresolve operation may refer to an operation where some information or data is copied (e.g., or transferred) from system memory 140 to GPU memory 130 (e.g., an operation where the old frame buffer is copied back into the bin buffer). For example, information rendered or written to a particular memory block of GMEM may be resolved and then unresolved (e.g., concurrently with a next rendering pass of a transaction associated with a memory address corresponding to the memory block), prior to overwriting by a next transaction.

A GPU 125 may implement various GMEM architectures or GMEM schemes for render/resolve operations. For example, in some cases, a GPU 125 may implement a double buffering GMEM, where rendering information may be written to a one location or region of GMEM while a second location or region of GMEM is resolved (e.g., GMEM may be partitioned into two regions, where a first region is used for writing render information and a second region is used for resolving render information of a previous bin). In such double buffering GMEM implementations, current render may be written to a different part or region of GMEM and any ‘resolve’ operation may be performed in a fixed order in the other part or region of GMEM. Similarly the double buffer may be used to do fixed order ‘unresolve’ or ‘clear’ operations prior to the GMEM region being ‘switched in’ (e.g., or transitioned to) as the render target. In some cases, such partitioning of GMEM (e.g., and fixed order transaction/memory operations) may be inefficient.

A device 100 may implement the techniques described herein for concurrent render and resolve (e.g., resolving of a first bin in parallel with rendering of a second bin). For example, device 100 may identify a memory address corresponding to a first transaction associated with a first bin of a frame (e.g., bin N). The device 100 may then concurrently perform a resolve operation, a clear operation, or an unresolve operation on a memory block (e.g., based at least in part on the identified memory address) while the device 100 identifies depth and color information of the first transaction. As such, graphic processing time associated with the resolve operation, the clear operation, or the unresolve operation (e.g., associated with a transaction of a previous bin N−1) may be consumed during (e.g., in parallel with) rendering of the first transaction. A device 100 may thus reduce graphic display time (e.g., graphic processing latency), as the device 100 may generally begin rendering of transactions without waiting for previous transaction to be resolved, cleared, etc. (e.g., as previous transactions stored in or associated with a memory block corresponding to a new transaction to be rendered may be resolved, cleared, etc. in parallel with the identification of depth and color information for the new transaction).

That is, when rendering a transaction to GMEM, device 100 may identify pixel coordinates, or pixel address (X, Y) information, associated with a transaction from a GPU pipeline (e.g., early in the rendering processing) and may identify a memory address, or memory block of the GMEM, based on the pixel coordinates. The device 100 may then update a transaction resolve priority based on the identified memory address such that the memory block corresponding to the transaction being rendered may be resolved, cleared, unresolved, etc. during the remaining rendering processing of the transaction. As such, a device may efficiently prepare the memory block (e.g., based on the operations performed according to the updated transaction resolve priority) such that concurrent render and resolve operations may be performed without additional memory bandwidth (e.g., without additional GMEM). That is, the described techniques may provide for the discussed graphic display time savings (e.g., reduced graphic processing latency) without additional GPU memory requirements (e.g., without necessarily increasing the size of the GMEM).

Generally, the described techniques (e.g., for identifying and utilizing GMEM location information at early stages in a GPU render processing pipeline) may be implemented for various operations on GPU memory 130, and may be applied via various GMEM architectures or GMEM implementations. Advanced notice of memory location information (e.g., identification of memory location information corresponding to a transaction early in a GPU render processing pipeline, versus identification of memory location information corresponding to a transaction subsequent to all or most of the GPU render processing) may be utilized in fixed region GMEM implementations, tag or cache GMEM architectures, partitioned GMEM implementations, etc.

For example, in some implementations, a fixed region GMEM may be configured such that there is 1:1 mapping between coordinates (e.g., pixel address (X, Y) information) and memory (e.g., GMEM) address. When a transaction reaches some early stage of a GPU processing pipeline (e.g., such as an LRZ block), a memory address (e.g., memory location information) can be identified or calculated from the coordinates of the transaction, and the transaction may go to a unique place in memory (e.g., the depth and color information, or other information from shader operations, may be written to a unique GMEM memory block corresponding to the memory address of that transaction). Therefore, pixel address (X, Y) information may be identified at an early stage the GPU processing pipeline in order to “free” up the memory (e.g., the unique GMEM memory block) in parallel while the transaction is being processed in shader (e.g., while the remaining transaction rendering processing continues, while depth and color information of the transaction is being identified, etc.).

Further, since there is 1:1 mapping for a GMEM block or GMEM region where depth and color information for a transaction will be written to, a GPU 125 may check whether the old data is resolved out before writing the “new” data (e.g., in fixed region GMEM where an individual memory block corresponds to the rendering of each transaction, no cache structure may be used and any tag compare operations may not be necessary). As described herein, identification of memory location information at an early stage of GPU processing pipeline in such fixed region GMEM may allow for overlapping (e.g., parallel performing) of shader operations (e.g., rendering operations, such as identification of depth and color information of a first transaction) with concurrent memory block operations (e.g., a resolve operation, an unresolve operation, a clear operation, etc.).

In other examples, in some implementations, a tag or cache GMEM may be configured such that the mapping between transaction coordinates and memory address is not fixed and the transaction can go into any available space in GMEM (e.g., a fully associative cache-based GMEM) or multiple available spaces in GMEM (e.g., a set associative cache-based GMEM). In such implementations a tag compare operation may be performed to see of the new data (e.g., depth and color information for a transaction or bin) is already assigned to one of the cache lines or if a new cache line needs to be allocated. In such cases, early stage memory location information identification may be used to allow ‘early miss’ processing (e.g., even if the cache is associative). If all ways are currently dirty, advance knowledge of memory location information may allow flushing one way without subsequent delay. Similarly if an ‘unresolve’ of that cache line is needed, the read latency may be overlapped with the shader latency.

For example, early in the GPU processing pipeline for cache-based architectures, memory location information (e.g., corresponding to a first transaction) may be identified that includes some indication of the memory address (e.g., such as an (X,Y) offset into a given frame buffer surface). This information may be readily converted to an actual memory location. In some cache-based implementations, such a memory address may include two parts, an ‘index’ (e.g., which is used for selecting a certain ‘set’ of cache lines) and a ‘tag’ (e.g., which indicates, for each cache line in the ‘set,’ what memory address may be present).

In some cases, the ‘index’ may not be included in the ‘tags’ for each set (e.g., only a single index may be possible in a given set). In some examples, ‘index’ and ‘tag’ may be two pieces of a linear address—or they could include some combination of surface identifier and (X,Y) offsets.

The ‘set’ may include multiple different cache lines (e.g., each cache line may be referred to as a ‘way’), each with a tag. Although there may be multiple ‘ways’ in a ‘set’—these are still a small fraction of the possible lines from the cached surface that could be present in the set. Hence the tag associated with each way may be checked against the incoming tag to see if there is a match. A match may be referred to as a ‘hit’ and may indicate that a given way holds the desired data from the surface. A ‘miss’ may indicate that none of the tags (e.g., one from each ‘way’ in the set) matches the incoming tag. Such may indicate that the given location from the surface is not present in the cache. A miss may result in throwing one of the ways out of the cache and bringing in new data from system memory to replace it. The tag for that way would then be updated to reflect the system memory location of the new data. In some examples, cache-based GMEM implementations may in some cases use memory location information (e.g., identified at an early stage of a GPU processing pipeline) to perform such a tag compare operation of a current tag with the memory location information corresponding to some first transaction.

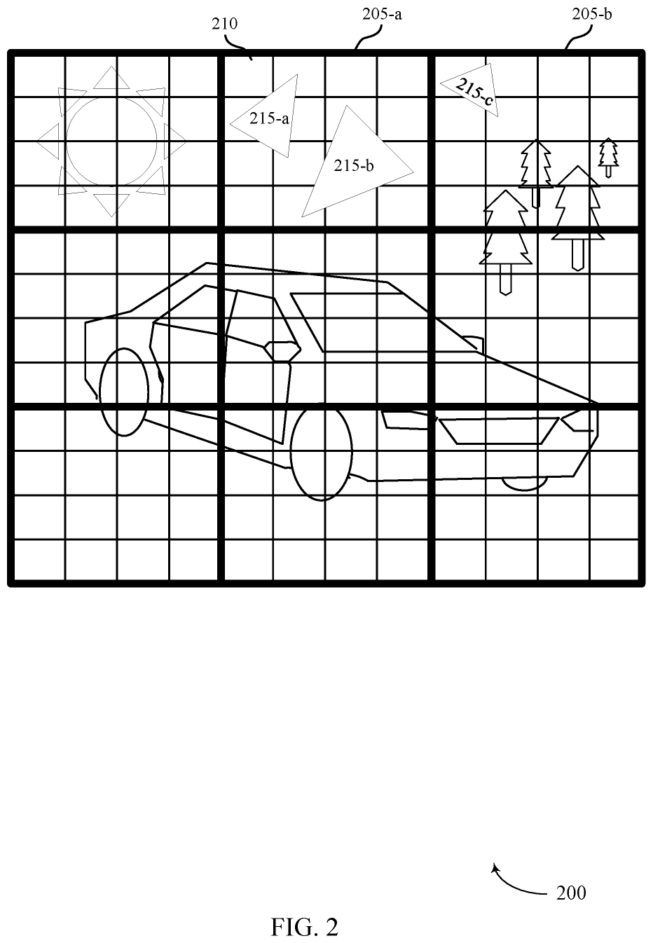

FIG. 2 illustrates an example of a binning layout 200 that supports bin resolve with concurrent rendering of a next bin in accordance with aspects of the present disclosure. In some examples, binning layout 200 may illustrate aspects of operations performed by device 100. An image or frame may be divided into a number of bins 205. Each bin 205 may be rendered/rasterized (e.g., by a GPU such as GPU 125) to contain multiple pixels 210, and pixels 210 may be shown via a display such as display 145. One or more transactions 215 (e.g., primitives) may be visible in each bin 205. During a rendering pass, transactions 215 in a bin 205 may be rendered.

In some cases, a frame may be divided into multiple bins, where the size of each bin is determined based on the size of the GMEM. For example, a graphic or frame may include several pixels 210 (e.g., depending on the resolution of the display). A device may process and store color and/or depth information for each pixel 210. However, due to limited internal memory, an entire frame or graphic may not always be able to be stored at once by a GPU. As such, a GPU may divide a frame or a display into bins 205, such that information for all pixels 210 within a bin may be stored in GMEM. A bin 205 may include one or more primitives, such as lines, triangles, etc. For example, each triangle may represent or be processed as one transaction 215 in some part of the GPU, and the triangle may be converted into pixels. In some cases, a transaction 215 may refer to a unit which flows through the GPU (e.g., one transaction 215 may flow through the GPU in one cycle).

For a given rendering pass, the pixel data for a transaction 215 (e.g., for a primitive) associated with that particular rendering pass may be stored in a GPU memory (e.g. GPU memory 130 described with reference to FIG. 1). Pixel information (e.g., pixel address (X, Y) information) associated with a transaction may dictate where in memory the pixel data for the transaction may be stored. For example, a CRE may identify pixel address (X, Y) information associated with a transaction, and may identify a memory address of a GMEM memory block based on the pixel address (X, Y) information. While performing the rendering pass, the CRE may transfer the contents of the memory block (e.g., based on the identified memory address) to system memory or to a display buffer. In some cases, the GPU may overwrite a portion of the data in the display buffer or system memory with the rendered data stored in the GPU memory. In some examples, after transferring the contents of GPU memory to the display buffer or system memory, the GPU may initialize the GPU memory to default values (e.g., which may all be performed concurrently with the rendering pass).

For example, a device (e.g., a GPU) may process an entire image and sort rasterized primitives (e.g., transactions) into bins. In the present example, transactions 215-a and 215-b may be included in a first bin 205-a, and transaction 215-c may be a first transaction of a second bin 205-b. The device may render transactions of a first bin (e.g., transactions 215-a and 215-b). The device may then proceed to rendering transactions of a second bin while concurrently performing resolve operations, clear operations, and unresolve operations (e.g., associated with the first bin) on memory blocks of the GPU memory. That is, for each transaction of the second bin 205-b (e.g., for transaction 215-c), the device may identify a memory address corresponding to the transaction 215-c of the next bin 205-b (e.g., at some early stage of the GPU processing pipeline) and may perform a resolve operation, a clear operation, or an unresolve operation on a memory block corresponding to the memory address, while the GPU continues to render the transaction 215-c in parallel (e.g., concurrently). For example, the device (e.g., the GPU, CRE, etc.) may identify depth and color information of the transaction 215-c while the resolve operation, the clear operation, or the unresolve operation is performed concurrently with the identifying of the depth and color information.

For example, transaction 215-a may be associated with a same GMEM memory block as transaction 215-c (e.g., transaction 215-a and transaction 215-c may be associated with a same memory address in GMEM, based on their pixel address (X, Y) information). Once transaction 215-c is identified for rendering, an upstream processing block (e.g., some early processing stage in a GPU rendering pipeline, such as a low depth resolution block) may pass some pixel information (e.g., pixel address (X, Y) information) to a CRE. The CRE may identify a memory address corresponding to the memory block (or location in GPU memory 130) that the pixel information will ultimately be rendered (e.g., written) to. The device may concurrently identify depth and color information of the transaction 215-c while the resolve operation, the clear operation, or the unresolve operation is performed on the memory block where the transaction 215-c will be rendered. As such, information (e.g., depth and color information of transaction 215-a in previously rendered bin 205-a) may be efficiently resolved, cleared, unresolved, etc., such that the depth and color information of the transaction 215-c being currently rendered may then be written to the memory block of the GMEM. After GPU 125 has rendered all of the bins associated with a frame (e.g., or a given rendering target) in this way, the display buffer and/or system memory may output the finished image to a display.

In some cases, a visibility pass may be performed for each bin 205 (e.g., or for the frame as a whole during a binning pass, to determine which primitives are visible in the final rendered scene). The visibility pass may be performed by a GPU or by specialized hardware (e.g., a hardware accelerator). For example, in some cases, some primitives may be behind one or more other primitives (e.g., may be occluded) and such occluded primitives (e.g., transactions 215) may not need to be rendered for a given bin 205.

As discussed above, such concurrent render and resolve techniques may reduce graphic display time (e.g., graphic processing latency) compared to sequential render resolve techniques. For example, once bin 205-a has been rendered, the device (e.g., GPU) may immediately begin rendering of bin 205-b, without waiting for bin 205-a to be resolved, cleared, etc. By concurrently resolving transactions of bin 205-a with rendering of transactions of bin 205-b, graphic display time may be reduced.

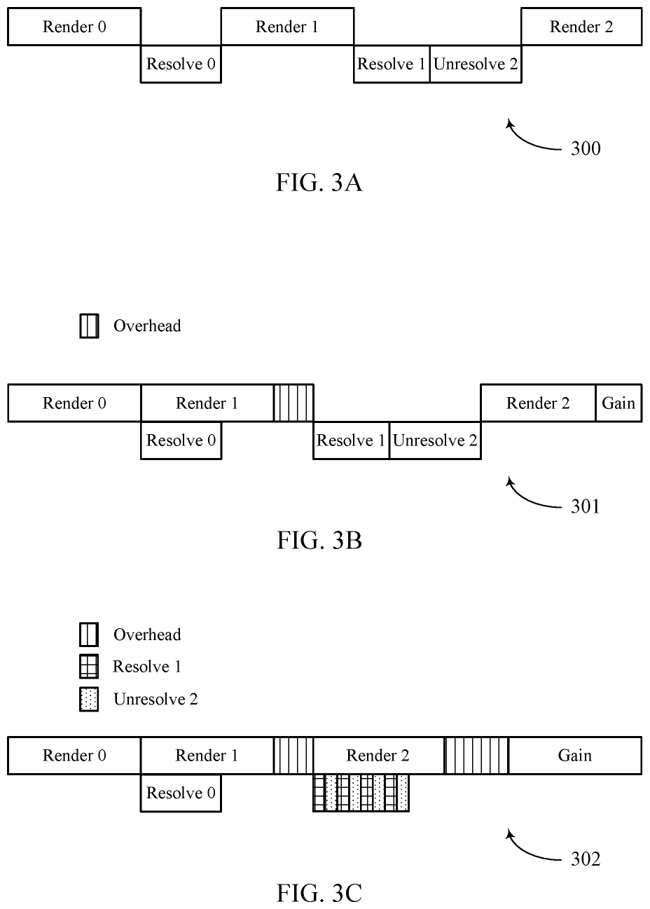

FIGS. 3A, 3B, and 3C illustrate example processing timelines that support bin resolve with concurrent rendering of a next bin in accordance with aspects of the present disclosure. In some examples, processing timelines 300, 301, and 302 may illustrate aspects of bin resolve with concurrent rendering techniques that may be performed by a device 100. It should be noted that additional or alternative operations and operation timings may implemented by analogy, without departing from the scope of the present disclosure. For example, in the examples of FIG. 3, unresolve operations may be replaced by clear operations, resolve operations may be coupled with clear operations, etc. Further, resolve operations, clear operations, and/or unresolve operations may be performed on a transaction basis, or in some cases may be performed based on some number of rendering passes being completed. In some cases, a GPU may maintain a memory block priority list (e.g., a transaction resolve priority list, a transaction clear priority list, a transaction unresolve priority list, etc.), and may perform resolve operations, clear operations, and unresolve operations according to the priority list. In some cases, the memory block operation priority list may be updated based on pixel address (X, Y) information associated with incoming transactions of a next bin to be rendered, and the GPU may perform operations on the memory block according to the priority list after some number of rendering passes (e.g., after some fraction of the bin has been rendered, such that any unwanted overwriting before resolution is unlikely).

As discussed herein, a rendering surface, a frame, a graphic, etc. may be divided into bins. In some cases, the bin size is determined by the size of the GMEM (e.g., the pixel color and depth information format and render target resolution divided by the total amount of GMEM). The number of bins may vary based on device hardware, target resolution size, and target display format. A rendering pass may draw (e.g., render, write, etc.) pixels into GMEM (e.g., with a high bandwidth that matches the capabilities of the GPU). A resolve pass may write blended pixel values from the GMEM to a display buffer or a frame buffer in system memory. In the following discussion, a ‘Render 0’ time unit may refer to an amount of time spent on operations relating to the rendering of a bin 0, a ‘Render 1’ time unit may refer to an amount of time spent on operations relating to the rendering of a bin 1, a ‘Resolve 0’ time unit may refer to an amount of time spent on operations relating to the resolve of a bin 0, and so on.

Processing timeline 300 of FIG. 3A may illustrate serial render and resolve techniques (e.g., where each transaction in a bin is rendered to GMEM, and the GMEM is sequentially resolved. For example, a GPU may render bin 0 and store the rendered bin 0 to GPU memory (e.g., ‘Render 0’). That is, a GPU may perform pixel shading and other operations to determine pixel values for each pixel of the bin 0, and may write the pixel values to GPU memory (e.g., GMEM). A GPU may then transfer the finished pixel values of the bin from GPU memory to a display buffer or to system memory (e.g., ‘Resolve 0’). Following ‘Resolve 0,’ the GPU may then begin rendering of a next bin (e.g., bin 1).

Processing timeline 301 of FIG. 3B may illustrate bin resolve with concurrent rendering of a next bin (e.g., where a transaction in a bin is rendered to a memory block in GMEM, while the memory block is resolved in parallel). For example, a GPU may render bin 0 and store the rendered bin 0 to GPU memory (e.g., ‘Render 0’). That is, a GPU may perform pixel shading and other operations to determine pixel values for each pixel of transactions of bin 0, and may write the pixel values for each transaction to a memory block in GPU memory (e.g., GMEM). A GPU may then begin to render bin 1 (e.g., a next bin) without pause for any bin/GMEM resolve operation, bin/GMEM clear operation, etc. For example, according to the described techniques, a GPU may identify a transaction of bin 1, and identify a memory address of a memory block associated with the rendering of the identified transaction. The GPU may then proceed with performing pixel shading and other operations to determine pixel values for the transaction (e.g., identify depth and color information of the transaction), while concurrently transferring the finished pixel values of the memory block (e.g., from a processed transaction of bin 0) from GPU memory to a display buffer or to system memory. As shown in example processing timeline 301 (e.g., illustrated as ‘Gain’), such concurrent render and resolve techniques (e.g., concurrent ‘Render 1’ and Resolve 0′ operations) may result in a reduced processing timeline. That is, implementation of processing timeline 301 may result in reduced graphic display time (e.g., as bins may be rendered and resolved more quickly) compared to processing timeline 300.

Processing timeline 302 of FIG. 3C may illustrate another example of bin resolve with concurrent rendering of a next bin (e.g., where a transaction in a bin is rendered to a memory block in GMEM, while the memory block is resolved, cleared, and/or unresolved in parallel). For example, a GPU may render bin 0 and store the rendered bin 0 to GPU memory (e.g., ‘Render 0’). That is, a GPU may perform pixel shading and other operations to determine pixel values for each pixel of transactions of bin 0, and may write the pixel values for each transaction to a memory block in GPU memory (e.g., GMEM). A GPU may then begin to render bin 1 (e.g., a next bin) without pause for any bin/GMEM resolve operation, bin/GMEM clear operation, etc. For example, according to the described techniques, a GPU may identify a transaction of bin 1, and identify a memory address of a memory block associated with the rendering of the identified transaction. The GPU may then proceed with performing pixel shading and other operations to determine pixel values for the transaction (e.g., identify depth and color information of the transaction), while concurrently transferring the finished pixel values of the memory block (e.g., from a processed transaction of bin 0) from GPU memory to a display buffer or to system memory.

After ‘Render 1,’ and any overhead (e.g., inefficiencies from concurrent operations, such as delay in resolve/unresolve operations), the GPU may then begin to render bin 2 (e.g., a next bin). During the rendering of bin 2, a first transaction of bin 2 may be identified and a memory address of a memory block associated with the rendering of the transaction of bin 2 may also be identified. The GPU may then resolve and unresolve the memory block during the remaining rendering processing of the first transaction of bin 2. That is, the ordering of the rendering of bin 2 may be followed when resolving bin 1 (e.g., as well as clear) and unresolving bin 2 (e.g., each pixel address (X, Y) for a transaction of bin 2 may be resolved and unresolved prior to moving to a next pixel address (X, Y), according to the memory block priority list). For example, the memory block operation priority list may be updated such that the resolve order of bin 1 is based on the render order of bin 2.

As shown in example processing timeline 302 (e.g., illustrated as ‘Gain’), such concurrent render and resolve techniques (e.g., concurrent ‘Render 1’ and Resolve 0′ operations, as well as concurrent ‘Render 2,’ ‘Resolve 1,’ and ‘Unresolve 2’ operations) may result in a reduced processing timeline. That is, implementation of processing timeline 302 may result in reduced graphic display time (e.g., as bins may be rendered and resolved more quickly) compared to processing timeline 300. In general, aspects of processing timeline 301 and processing timeline 302 may illustrate processing such that process resolve of (N−1)^{th} bin may be performed concurrently with render of the N^{th} bin.

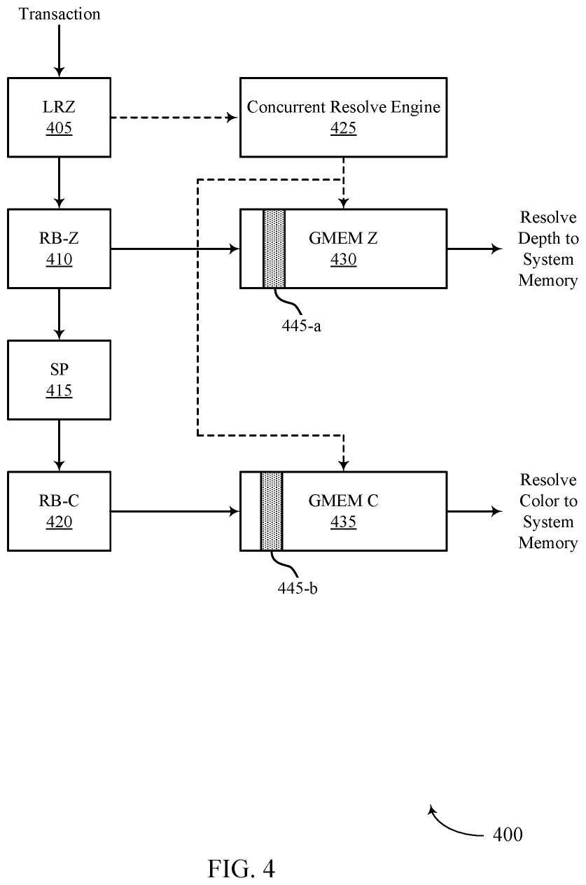

FIG. 4 illustrates an example of a GPU processing pipeline 400 that supports bin resolve with concurrent rendering of a next bin in accordance with aspects of the present disclosure. In some examples, GPU processing pipeline 400 may illustrate aspects of the described techniques as performed by device 100 (e.g., by a GPU 125). In general, a GPU may process a graphic according to some GPU pipeline (e.g., GPU processing pipeline 400). GPU processing pipeline 400 may begin with the identification of a transaction for rendering (e.g., the identification of a transaction render pass), and may end with a final stage where the depth and color information of the transaction is written to GMEM. GPU processing pipeline 400 may include a depth resolution block (e.g., a low resolution Z (LRZ) block 405), render backend blocks (e.g., render backend depth (RB-Z) block 410 and render backend color (RB-C) block 420, as well as other processing blocks (e.g., streaming processor (SP) block 415). GPU processing pipeline 400 may further include a concurrent resolve engine (CRE) 425, as well as GMEM (e.g., GMEM depth storage (GMEM Z) 430 and GMEM color storage (GMEM C) 435).

During rendering of a bin, each transaction (e.g., triangle/pixel) may flows in the GPU pipeline from one unit to another and finally written into GMEM (e.g., as shown by the solid arrows). While the transaction is in an upstream unit (e.g., LRZ block 405), it is possible to know the address/location in the GMEM (e.g., the memory address associated with a memory block 445) which will be accessed when the transaction reaches the final stages of GPU pipeline (e.g., the RB-Z block 410 and the RB-C block 420). For example, in the time it takes for a transaction to travel from LRZ block 405 to RB/GMEM, the CRE 425 may perform a resolve operation, a clear operation, and/or an unresolve operation on the memory block 445.

As indicated in GPU processing pipeline 400, when the transaction reaches LRZ block 405, CRE 425 may send an early signal to GMEM to prepare (e.g., or resolve out) the location of the GMEM which the transaction is going to access when it reaches RB-Z/RB-C. The GMEM may resolve/clear out the data from rendering of the previous bin during the time it takes transaction to travel from LRZ block 405 to RB/GMEM. When the transaction reaches RB, that part of the GMEM is already freed up (e.g., as shown by the dashed arrows).

That is, concurrent render resolve techniques may provide for resolving of an (N−1)^{th} bin in parallel with rendering of an N^{th} bin. During the render phase, when a transaction reaches an early processing stage (e.g., the LRZ block 405 in the example of FIG. 4), the a CRE 425 may be notified of the pixel address (X, Y). The CRE may identify a memory address of a memory block 445 corresponding to the pixel address (X, Y), and may free up space in GMEM corresponding to that pixel. The CRE may reorder the resolve transactions, and give priority to resolving out the GMEM data in the space where pixel (X, Y) will be written (e.g., memory block 445). At a later time, when the pixel (X, Y) reaches GMEM, the associated area in GMEM is already prepared (resolved, cleared, unresolved) for the pixel (X, Y).

LRZ block 405 may be generalized to any early GPU processing stage where the pixel address (X, Y) is known. A GPU (e.g., via a CRE 425) may utilize delay in rendering processing (e.g., delays from LRZ block 405 processing, RB-Z block 410 processing, SP block 415 processing, RB-C block 420 processing) to concurrently perform efficient GMEM resolve operations, GMEM clear operations, and/or GMEM unresolve operations. A device (e.g., a GPU or CRE) may thus identify a pixel address (X, Y) (e.g., a transaction identification (ID) and may identify a memory address corresponding to a memory block where the transaction will be written in GMEM. The device may resolve the memory block for the previous bin and the clear the memory block while the transaction proceeds through the remainder of the GPU processing pipeline 400. As such, the transaction may be written automatically (e.g., without waiting for a bin resolve operation, a bin clear operation, etc.), thus reducing graphics display latency.

In general, the CRE 425 may take information from an upstream unit (e.g., an early GPU rendering stage), and translate the information into a GMEM address. For a resolve operation, the CRE 425 may read the memory block corresponding to the GMEM address, and send the transaction to system memory. For a clear operation, the CRE 425 may take the pixel address (X, Y) location, and determine what value is to be cleared and write an initial value into that GMEM address (e.g., into that memory block). For an unresolve operation, the CRE 425 may take the pixel address (X, Y) location, determine a GMEM address based on the pixel address (X, Y) location, ready the system memory data, and write the data into the relevant address of the GMEM. In some cases, CRE 425 may refer to a processor or other hardware, or software, for performing the techniques described above.

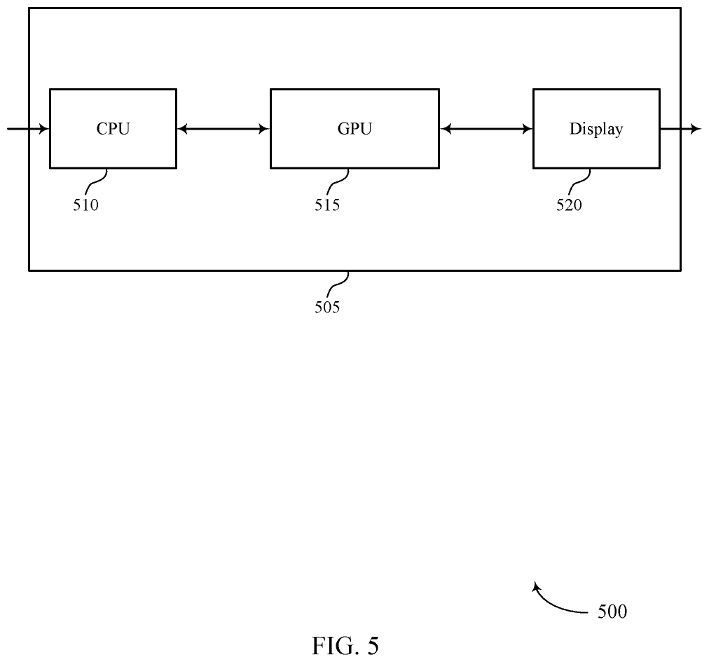

FIG. 5 shows a block diagram 500 of a device 505 that supports bin resolve with concurrent rendering of a next bin in accordance with aspects of the present disclosure. The device 505 may be an example of aspects of a device 100 as described herein. The device 505 may include a CPU 510, a GPU 515, and a display 520. In some cases, the device 505 may also include a general processor. Each of these components may be in communication with one another (e.g., via one or more buses).

CPU 510 may be an example of CPU 110 described with reference to FIG. 1. CPU 510 may execute one or more software applications, such as web browsers, graphical user interfaces, video games, or other applications involving graphics rendering for image depiction (e.g., via display 520). As described above, CPU 510 may encounter a GPU program (e.g., a program suited for handling by GPU 515) when executing the one or more software applications. Accordingly, CPU 510 may submit rendering commands to GPU 515 (e.g., via a GPU driver containing a compiler for parsing API-based commands).

The GPU 515 may identify memory location information corresponding to a first transaction associated with a first bin of a frame, perform, based on the identified memory location information, one or more of a resolve operation, a clear operation, an unresolve operation, or a tag compare operation, identify depth and color information of the first transaction, where the resolve operation, the clear operation, the unresolve operation, or the tag compare operation is performed concurrently with the identifying of the depth and color information of the first transaction, and write the depth and color information of the first transaction based on the resolve operation, the clear operation, the unresolve operation, or the tag compare operation. The GPU 515 may be an example of aspects of the GPU 810 described herein.

The GPU 515, or its sub-components, may be implemented in hardware, code (e.g., software or firmware) executed by a processor, or any combination thereof. If implemented in code executed by a processor, the functions of the GPU 515, or its sub-components may be executed by a general-purpose processor, a DSP, an application-specific integrated circuit (ASIC), a FPGA or other programmable logic device, discrete gate or transistor logic, discrete hardware components, or any combination thereof designed to perform the functions described in the present disclosure.

The GPU 515, or its sub-components, may be physically located at various positions, including being distributed such that portions of functions are implemented at different physical locations by one or more physical components. In some examples, the GPU 515, or its sub-components, may be a separate and distinct component in accordance with various aspects of the present disclosure. In some examples, the GPU 515, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

Display 520 may display content generated by other components of the device. Display 520 may be an example of display 145 as described with reference to FIG. 1. In some examples, display 520 may be connected with a display buffer which stores rendered data until an image is ready to be displayed (e.g., as described with reference to FIG. 1).

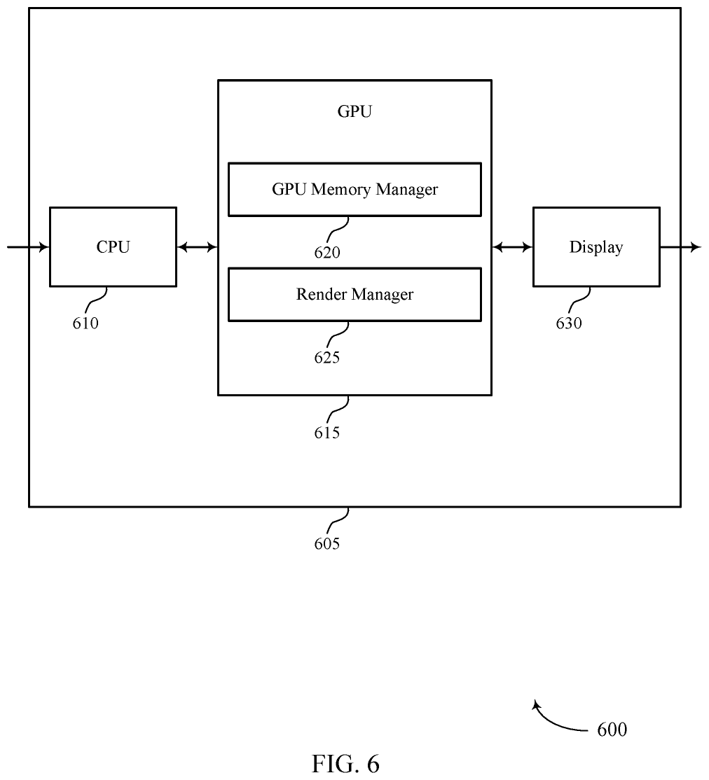

FIG. 6 shows a block diagram 600 of a device 605 that supports bin resolve with concurrent rendering of a next bin in accordance with aspects of the present disclosure. The device 605 may be an example of aspects of a device 505 or a device 100 as described herein. The device 605 may include a CPU 610, a GPU 615, and a display 630. The device 605 may also include a processor. Each of these components may be in communication with one another (e.g., via one or more buses).

CPU 610 may be an example of CPU 110 described with reference to FIG. 1. CPU 610 may execute one or more software applications, such as web browsers, graphical user interfaces, video games, or other applications involving graphics rendering for image depiction (e.g., via display 635). As described above, CPU 610 may encounter a GPU program (e.g., a program suited for handling by GPU 615) when executing the one or more software applications. Accordingly, CPU 610 may submit rendering commands to GPU 615 (e.g., via a GPU driver containing a compiler for parsing API-based commands).

The GPU 615 may be an example of aspects of the GPU 515 as described herein. The GPU 615 may include a GPU memory manager 620 and a render manager 625. The GPU 615 may be an example of aspects of the GPU 810 described herein.

The GPU memory manager 620 may identify memory location information corresponding to a first transaction associated with a first bin of a frame and perform, based on the identified memory location information, one or more of a resolve operation, a clear operation, an unresolve operation, or a tag compare operation. The render manager 625 may identify depth and color information of the first transaction, where the resolve operation, the clear operation, the unresolve operation, or the tag compare operation is performed concurrently with the identifying of the depth and color information of the first transaction and write the depth and color information of the first transaction based on the resolve operation, the clear operation, the unresolve operation, or the tag compare operation.

Display 635 may display content generated by other components of the device. Display 635 may be an example of display 145 as described with reference to FIG. 1. In some examples, display 635 may be connected with a display buffer which stores rendered data until an image is ready to be displayed (e.g., as described with reference to FIG. 1).

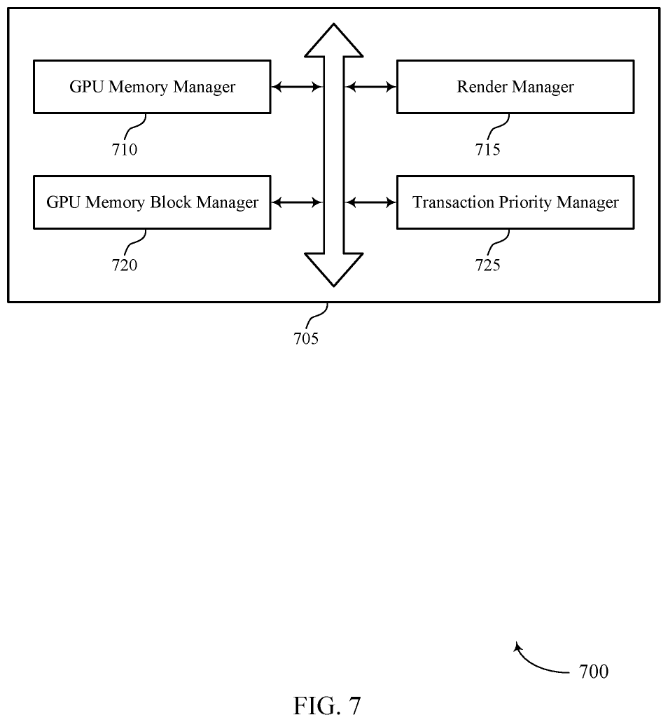

FIG. 7 shows a block diagram 700 of a GPU 705 that supports bin resolve with concurrent rendering of a next bin in accordance with aspects of the present disclosure. The GPU 705 may be an example of aspects of a GPU 515, a GPU 615, or a GPU 810 described herein. The GPU 705 may include a GPU memory manager 710, a render manager 715, a GPU memory block manager 720, and a transaction priority manager 725. Each of these modules may communicate, directly or indirectly, with one another (e.g., via one or more buses).

The GPU memory manager 710 may identify memory location information corresponding to a first transaction associated with a first bin of a frame. In some examples, the render manager 715 may identify pixel coordinates of the first transaction from a graphic processing unit pipeline, where the memory location information is identified based on the identified pixel coordinates. In some cases, the GPU memory manager 710 may identify a memory address corresponding to the first transaction (e.g., the memory location information may include or refer to a memory address corresponding to the first transaction in a fixed region GMEM implementation). In some cases, the GPU memory manager 710 may identify a cache line index, a tag indicating a presence of a memory address for each cache line corresponding to the cache line index, or both (e.g., the memory location information may include or refer to some indication of a memory address or region in a cache-based GMEM implementation, such as a cache line index, a tag indicating a presence of a memory address for each cache line corresponding to the cache line index, or both).

In some examples, the GPU memory manager 710 may perform, based on the identified memory location information, one or more of a resolve operation, a clear operation, an unresolve operation, or a tag compare operation. For example, in a fixed region GMEM implementation, the GPU memory manager 710 may perform one or more of a resolve operation, a clear operation, an unresolve operation on a memory block corresponding to the identified memory address (e.g., corresponding to the first transaction) concurrently or in parallel with the rendering (e.g., identification of depth and color information) of the first transaction. In other examples, in a cache-based GMEM implementation, the GPU memory manager 710 may perform a tag compare operation based on a cache line index or a tag indicating a presence of a memory address for each cache line corresponding to the cache line index (e.g., corresponding to the first transaction) concurrently or in parallel with the rendering (e.g., identification of depth and color information) of the first transaction.

The render manager 715 may identify depth and color information of the first transaction, where the resolve operation, the clear operation, the unresolve operation, or the tag compare operation is performed concurrently with the identifying of the depth and color information of the first transaction. In some examples, the render manager 715 may write the depth and color information of the first transaction based on the resolve operation, the clear operation, the unresolve operation, or the tag compare operation. In some examples, the render manager 715 may identify depth and color information of the second transaction, where the memory block is resolved concurrently with the identifying of the depth and color information of the second transaction.

The transaction priority manager 725 may update a transaction resolve priority based on the identified memory address, where the resolve operation, the clear operation, or the unresolve operation is performed based on the updated transaction resolve priority. In some examples, the transaction priority manager 725 may identify a second transaction associated with a second bin of the frame.

In some examples, the GPU memory block manager 720 may identify pixel coordinates of the first transaction from a graphic processing unit pipeline, where the memory address is identified based on the identified pixel coordinates. In some cases, the depth and color information of the first transaction is written to the memory block based on the identified memory address. The GPU memory block manager 720 may resolve a memory block to a frame buffer in system memory, where the depth and color information of the first transaction is written to the memory block based on the resolve operation, the clear operation, or the unresolve operation.

In some examples, the GPU memory block manager 720 may identify the memory address corresponds to the second transaction, where the memory block is resolved based on the identified memory address. In some cases, the performing on the memory block, based on the identified memory address, one or more of a resolve operation, a clear operation, or an unresolve operation includes performing the resolve operation, the clear operation, or the unresolve operation on a second transaction associated with a second bin of the frame based on the identified memory address, where the second bin precedes the first bin.

In some cases, the performing the resolve operation on the second transaction includes copying depth and color information of the second transaction from the memory block to the frame buffer in system memory, where the depth and color information of the first transaction is identified concurrently with the copying. In some cases, the performing the clear operation on the second transaction includes writing an initializing value to the memory block based on the identified memory address, where the depth and color information of the first transaction is identified concurrently with the writing. In some examples, performing the unresolve operation on the second transaction includes copying data from the frame buffer in system memory to the memory block based on the identified memory address, where the depth and color information of the first transaction is identified concurrently with the copying.

In some examples, the GPU memory block manager 720 may perform the resolve operation, the clear operation, or the unresolve operation on a second transaction associated with a second bin (e.g., a transaction of a previous bin (N−1)) of the frame based on the identified memory address, where the second bin precedes the first bin. In some examples, the GPU memory block manager 720 may copy depth and color information of the second transaction from the memory block to the frame buffer in system memory, where the depth and color information of the first transaction is identified concurrently with the copying. In some examples, the GPU memory block manager 720 may write an initializing value to the memory block based on the identified memory address, where the depth and color information of the first transaction is identified concurrently with the writing. In some examples, the GPU memory block manager 720 may copy data from the frame buffer in system memory to the memory block based on the identified memory address, where the depth and color information of the first transaction is identified concurrently with the copying.

In some examples, the transaction priority manager 725 may identify a second transaction associated with a second bin of the frame (e.g., a transaction of a subsequent bin (N+1)). In some examples, the render manager 715 may identify depth and color information of the second transaction, where the memory block is resolved concurrently with the identifying of the depth and color information of the second transaction. In some examples, the GPU memory manager 710 may identify the memory address corresponds to the second transaction, where the memory block is resolved based on the identified memory address.

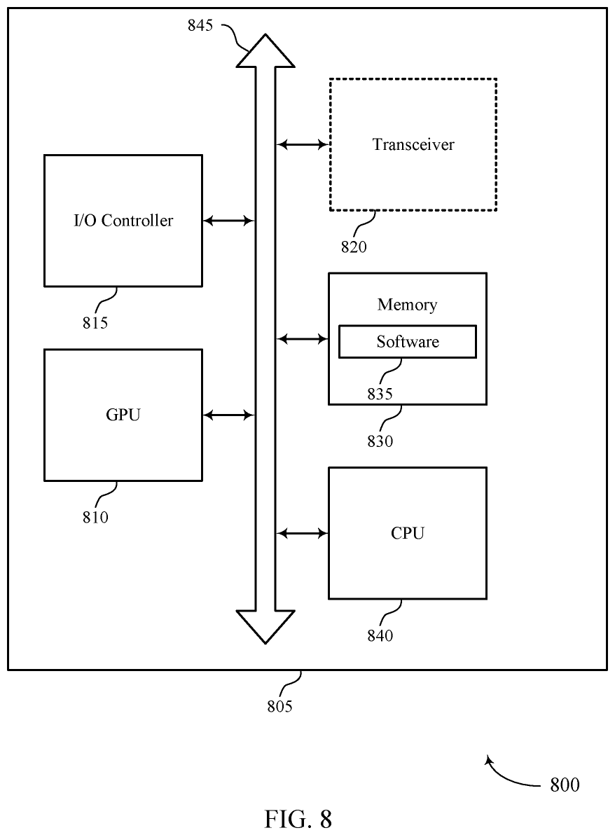

FIG. 8 shows a diagram of a system 800 including a device 805 that supports bin resolve with concurrent rendering of a next bin in accordance with aspects of the present disclosure. The device 805 may be an example of or include the components of device 505, device 605, or a device 100 as described herein. The device 805 may include a GPU 810, an I/O controller 815, memory 830, and a processor or CPU 840. In some cases, device 805 may include a transceiver 820. These components may be in electronic communication via one or more buses (e.g., bus 845).

The GPU 810 may identify memory location information corresponding to a first transaction associated with a first bin of a frame, perform, based on the identified memory location information, one or more of a resolve operation, a clear operation, an unresolve operation, or a tag compare operation, identify depth and color information of the first transaction, where the resolve operation, the clear operation, the unresolve operation, or the tag compare operation is performed concurrently with the identifying of the depth and color information of the first transaction, and write the depth and color information of the first transaction based on the resolve operation, the clear operation, the unresolve operation, or the tag compare operation.

CPU 840 may include an intelligent hardware device, (e.g., a general-purpose processor, a DSP, a microcontroller, an ASIC, an FPGA, a programmable logic device, a discrete gate or transistor logic component, a discrete hardware component, or any combination thereof). In some cases, CPU 840 may be configured to operate a memory array using a memory controller. In other cases, a memory controller may be integrated into CPU 840. CPU 840 may be configured to execute computer-readable instructions stored in a memory to perform various functions (e.g., functions or tasks supporting dynamic bin ordering for load synchronization).

The I/O controller 815 may manage input and output signals for the device 805. The I/O controller 815 may also manage peripherals not integrated into the device 805. In some cases, the I/O controller 815 may represent a physical connection or port to an external peripheral. In some cases, the I/O controller 815 may utilize an operating system such as iOS®, ANDROID®, MS-DOS®, MS-WINDOWS®, OS/2®, UNIX®, LINUX®, or another known operating system. In other cases, the I/O controller 815 may represent or interact with a modem, a keyboard, a mouse, a touchscreen, or a similar device. In some cases, the I/O controller 815 may be implemented as part of a processor. In some cases, a user may interact with the device 805 via the I/O controller 815 or via hardware components controlled by the I/O controller 815.

The transceiver 820 may communicate bi-directionally, via one or more antennas, wired, or wireless links as described above. For example, the transceiver 820 may represent a wireless transceiver and may communicate bi-directionally with another wireless transceiver. The transceiver 820 may also include a modem to modulate the packets and provide the modulated packets to the antennas for transmission, and to demodulate packets received from the antennas.

The memory 830 may include RAM and ROM. The memory 830 may store computer-readable, computer-executable code or software 835 including instructions that, when executed, cause the processor to perform various functions described herein. In some cases, the memory 830 may contain, among other things, a BIOS which may control basic hardware or software operation such as the interaction with peripheral components or devices.

In some cases, the GPU 810 and/or the CPU 840 may include an intelligent hardware device, (e.g., a general-purpose processor, a DSP, a microcontroller, an ASIC, an FPGA, a programmable logic device, a discrete gate or transistor logic component, a discrete hardware component, or any combination thereof). In some cases, the GPU 810 and/or the CPU 840 may be configured to operate a memory array using a memory controller. In other cases, a memory controller may be integrated into the GPU 810 and/or the CPU 840. The GPU 810 and/or the CPU 840 may be configured to execute computer-readable instructions stored in a memory (e.g., the memory 830) to cause the device 805 to perform various functions (e.g., functions or tasks supporting bin resolve with concurrent rendering of a next bin).

The software 835 may include instructions to implement aspects of the present disclosure, including instructions to support image processing at a device. The software 835 may be stored in a non-transitory computer-readable medium such as system memory or other type of memory. In some cases, the software 835 may not be directly executable by the CPU 840 but may cause a computer (e.g., when compiled and executed) to perform functions described herein.

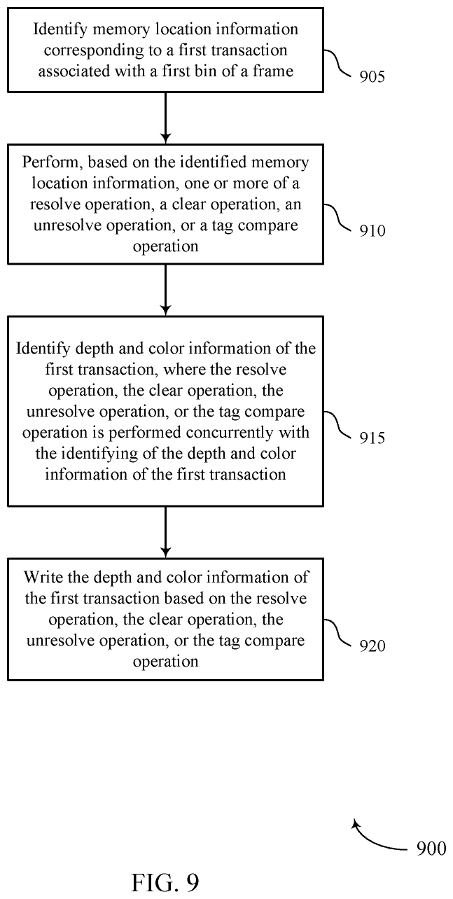

FIG. 9 shows a flowchart illustrating a method 900 that supports bin resolve with concurrent rendering of next bin in accordance with aspects of the present disclosure. The operations of method 900 may be implemented by a device or its components as described herein. For example, the operations of method 900 may be performed by a GPU as described with reference to FIGS. 5 through 8. In some examples, a device may execute a set of instructions to control the functional elements of the device to perform the functions described below. Additionally or alternatively, a device may perform aspects of the functions described below using special-purpose hardware.

At 905, the device may identify memory location information corresponding to a first transaction associated with a first bin of a frame. The operations of 905 may be performed according to the methods described herein. In some examples, aspects of the operations of 905 may be performed by a GPU memory manager as described with reference to FIGS. 5 through 8.

At 910, the device may perform, based on the identified memory location information, one or more of a resolve operation, a clear operation, an unresolve operation, or a tag compare operation. The operations of 910 may be performed according to the methods described herein. In some examples, aspects of the operations of 910 may be performed by a GPU memory manager as described with reference to FIGS. 5 through 8.

At 915, the device may identify depth and color information of the first transaction, where the resolve operation, the clear operation, the unresolve operation, or the tag compare operation is performed concurrently with the identifying of the depth and color information of the first transaction. The operations of 915 may be performed according to the methods described herein. In some examples, aspects of the operations of 915 may be performed by a render manager as described with reference to FIGS. 5 through 8.

At 920, the device may write the depth and color information of the first transaction based on the resolve operation, the clear operation, the unresolve operation, or the tag compare operation. The operations of 920 may be performed according to the methods described herein. In some examples, aspects of the operations of 920 may be performed by a render manager as described with reference to FIGS. 5 through 8.

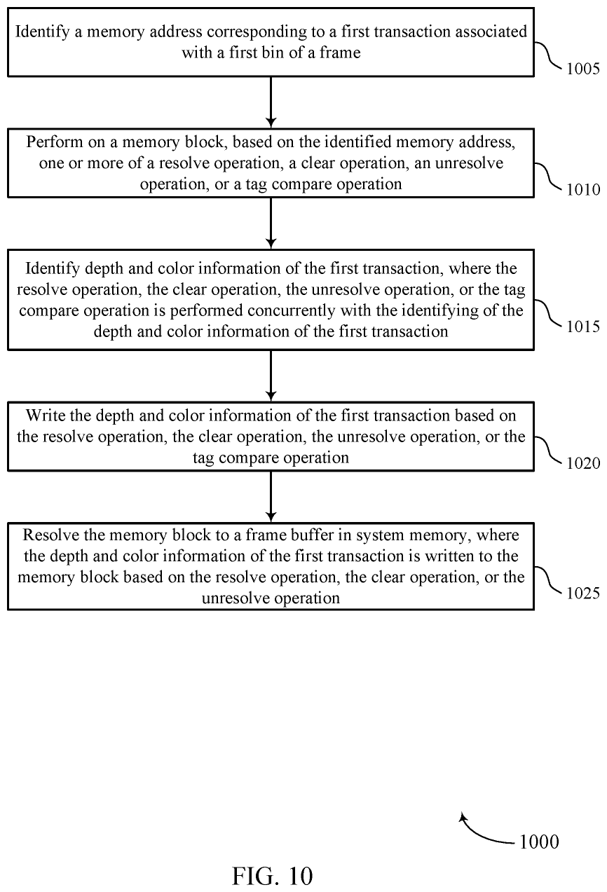

FIG. 10 shows a flowchart illustrating a method 1000 that supports bin resolve with concurrent rendering of next bin in accordance with aspects of the present disclosure. The operations of method 1000 may be implemented by a device or its components as described herein. For example, the operations of method 1000 may be performed by a GPU as described with reference to FIGS. 5 through 8. In some examples, a device may execute a set of instructions to control the functional elements of the device to perform the functions described below. Additionally or alternatively, a device may perform aspects of the functions described below using special-purpose hardware.

At 1005, the device may identify a memory address corresponding to a first transaction associated with a first bin of a frame. The operations of 1005 may be performed according to the methods described herein. In some examples, aspects of the operations of 1005 may be performed by a GPU memory manager as described with reference to FIGS. 5 through 8.

At 1010, the device may perform on a memory block, based on the identified memory address, one or more of a resolve operation, a clear operation, an unresolve operation, or a tag compare operation. The operations of 1010 may be performed according to the methods described herein. In some examples, aspects of the operations of 1010 may be performed by a GPU memory manager as described with reference to FIGS. 5 through 8.

At 1015, the device may identify depth and color information of the first transaction, where the resolve operation, the clear operation, the unresolve operation, or the tag compare operation is performed concurrently with the identifying of the depth and color information of the first transaction. The operations of 1015 may be performed according to the methods described herein. In some examples, aspects of the operations of 1015 may be performed by a render manager as described with reference to FIGS. 5 through 8.

At 1020, the device may write the depth and color information of the first transaction based on the resolve operation, the clear operation, the unresolve operation, or the tag compare operation. The operations of 1020 may be performed according to the methods described herein. In some examples, aspects of the operations of 1020 may be performed by a render manager as described with reference to FIGS. 5 through 8.

At 1025, the device may resolve the memory block to a frame buffer in system memory, where the depth and color information of the first transaction is written to the memory block based on the resolve operation, the clear operation, or the unresolve operation. The operations of 1025 may be performed according to the methods described herein. In some examples, aspects of the operations of 1025 may be performed by a GPU memory block manager as described with reference to FIGS. 5 through 8.

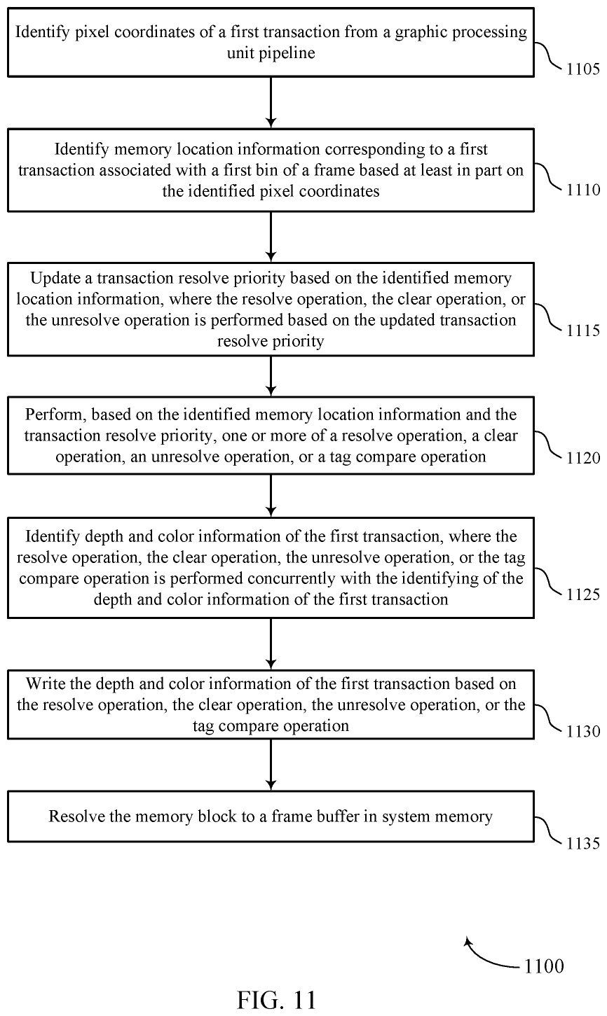

FIG. 11 shows a flowchart illustrating a method 1100 that supports bin resolve with concurrent rendering of next bin in accordance with aspects of the present disclosure. The operations of method 1100 may be implemented by a device or its components as described herein. For example, the operations of method 1100 may be performed by a GPU as described with reference to FIGS. 5 through 8. In some examples, a device may execute a set of instructions to control the functional elements of the device to perform the functions described below. Additionally or alternatively, a device may perform aspects of the functions described below using special-purpose hardware.

At 1105, the device may identify pixel coordinates of a first transaction from a graphic processing unit pipeline, where the memory address is identified based on the identified pixel coordinates. The operations of 1105 may be performed according to the methods described herein. In some examples, aspects of the operations of 1105 may be performed by a GPU memory block manager as described with reference to FIGS. 5 through 8.

At 1110, the device may identify memory location information corresponding to a first transaction associated with a first bin of a frame based at least in part on the identified pixel coordinates. For example, the device may identify a memory address (e.g., of a memory block of the GPU memory) based on the identified pixel coordinates. The operations of 1110 may be performed according to the methods described herein. In some examples, aspects of the operations of 1110 may be performed by a GPU memory manager as described with reference to FIGS. 5 through 8.

At 1115, the device may update a transaction resolve priority based on the identified memory location information, where the resolve operation, the clear operation, or the unresolve operation is performed based on the updated transaction resolve priority. For example, the transaction resolve priority may be updated such that the resolve operation, the clear operation, or the unresolve operation is performed on the memory block corresponding to the identified memory location information (e.g., corresponding to the first transaction) earlier (e.g., concurrently with the identification of depth and color information of the first transaction). The operations of 1115 may be performed according to the methods described herein. In some examples, aspects of the operations of 1115 may be performed by a transaction priority manager as described with reference to FIGS. 5 through 8.

At 1120, the device may perform, based on the identified memory location information and the transaction resolve priority, one or more of a resolve operation, a clear operation, an unresolve operation, or a tag compare operation. The operations of 1120 may be performed according to the methods described herein. In some examples, aspects of the operations of 1120 may be performed by a GPU memory manager as described with reference to FIGS. 5 through 8.

At 1125, the device may identify depth and color information of the first transaction, where the resolve operation, the clear operation, the unresolve operation, or the tag compare operation is performed concurrently with the identifying of the depth and color information of the first transaction. The operations of 1125 may be performed according to the methods described herein. In some examples, aspects of the operations of 1125 may be performed by a render manager as described with reference to FIGS. 5 through 8.

At 1130, the device may write the depth and color information of the first transaction based on the resolve operation, the clear operation, the unresolve operation, or the tag compare operation. The operations of 1130 may be performed according to the methods described herein. In some examples, aspects of the operations of 1130 may be performed by a render manager as described with reference to FIGS. 5 through 8.

At 1135, the device may resolve the memory block to a frame buffer in system memory. In some cases, the memory block may be resolved based on the device identifying pixel coordinates of a subsequent transaction that correspond to the memory block (e.g., the memory block may be resolved based on rendering of a later transaction to the memory block). The operations of 1135 may be performed according to the methods described herein. In some examples, aspects of the operations of 1135 may be performed by a GPU memory block manager as described with reference to FIGS. 5 through 8.

It should be noted that the methods described herein describe possible implementations, and that the operations and the steps may be rearranged or otherwise modified and that other implementations are possible. Further, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read-only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, digital subscriber line (DSL), or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for image processing at a device, comprising:
identifying memory location information corresponding to a first transaction associated with a first bin of a frame;
performing based at least in part on the identified memory location information, one or more of a resolve operation, a clear operation, an unresolve operation, or a tag compare operation;
identifying depth and color information of the first transaction, wherein the resolve operation, the clear operation, the unresolve operation, or the tag compare operation is performed concurrently with the identifying of the depth and color information of the first transaction; and
writing the depth and color information of the first transaction based at least in part on the resolve operation, the clear operation, the unresolve operation, or the tag compare operation.

2. The method of claim 1, wherein identifying the memory location information comprises:
identifying a memory address corresponding to the first transaction.

3. The method of claim 2, further comprising:
resolving a memory block to a frame buffer in system memory, wherein the depth and color information of the first transaction is written to the memory block based at least in part on the resolve operation, the clear operation, or the unresolve operation.

4. The method of claim 3, further comprising:
updating a transaction resolve priority based at least in part on the identified memory address, wherein the resolve operation, the clear operation, or the unresolve operation is performed based at least in part on the updated transaction resolve priority.

5. The method of claim 3, further comprising:
identifying pixel coordinates of the first transaction from a graphic processing unit pipeline, wherein the memory address is identified based at least in part on the identified pixel coordinates.

6. The method of claim 3, wherein performing on the memory block, based at least in part on the identified memory address, one or more of the resolve operation, the clear operation, or the unresolve operation comprises:
performing the resolve operation, the clear operation, or the unresolve operation on a second transaction associated with a second bin of the frame based at least in part on the identified memory address, wherein the second bin precedes the first bin.

7. The method of claim 6, wherein performing the resolve operation on the second transaction comprises:
copying depth and color information of the second transaction from the memory block to the frame buffer in system memory, wherein the depth and color information of the first transaction is identified concurrently with the copying.

8. The method of claim 6, wherein performing the clear operation on the second transaction comprises:
writing an initializing value to the memory block based at least in part on the identified memory address, wherein the depth and color information of the first transaction is identified concurrently with the writing.

9. The method of claim 6, wherein performing the unresolve operation on the second transaction comprises:
copying data from the frame buffer in system memory to the memory block based at least in part on the identified memory address, wherein the depth and color information of the first transaction is identified concurrently with the copying.

10. The method of claim 3, wherein the depth and color information of the first transaction is written to the memory block based at least in part on the identified memory address.

11. The method of claim 3, further comprising:
identifying a second transaction associated with a second bin of the frame; and
identifying the memory address corresponds to the second transaction, wherein the memory block is resolved based at least in part on the identified memory address.

12. The method of claim 11, further comprising:
identifying depth and color information of the second transaction, wherein the memory block is resolved concurrently with the identifying of the depth and color information of the second transaction.

13. The method of claim 1 wherein identifying the memory location information comprises:
identifying a cache line index, a tag indicating a presence of a memory address for each cache line corresponding to the cache line index, or both.

14. An apparatus for image processing at a device, comprising:
a processor,
memory in electronic communication with the processor; and
instructions stored in the memory and executable by the processor to cause the apparatus to:
identify memory location information corresponding to a first transaction associated with a first bin of a frame;
perform based at least in part on the identified memory location information, one or more of a resolve operation, a clear operation, or an unresolve operation, or a tag compare operation;
identify depth and color information of the first transaction, wherein the resolve operation, the clear operation, the unresolve operation, or the tag compare operation is performed concurrently with the identifying of the depth and color information of the first transaction; and
write the depth and color information of the first transaction block based at least in part on the resolve operation, the clear operation, the unresolve operation, or the tag compare operation.

15. The apparatus of claim 14, wherein the instructions to identify the memory location information are executable by the processor to cause the apparatus to:
identify a memory address corresponding to the first transaction.

16. The apparatus of claim 15, wherein the instructions are further executable by the processor to cause the apparatus to:
resolve a memory block to a frame buffer in system memory, wherein the depth and color information of the first transaction is written to the memory block based at least in part on the resolve operation, the clear operation, or the unresolve operation

17. The apparatus of claim 16, wherein the instructions are further executable by the processor to cause the apparatus to:
update a transaction resolve priority based at least in part on the identified memory address, wherein the resolve operation, the clear operation, or the unresolve operation is performed based at least in part on the updated transaction resolve priority.

18. The apparatus of claim 16, wherein the instructions are further executable by the processor to cause the apparatus to:
identify pixel coordinates of the first transaction from a graphic processing unit pipeline, wherein the memory address is identified based at least in part on the identified pixel coordinates.

19. The apparatus of claim 16, wherein the instructions to perform on the memory block, based at least in part on the identified memory address, one or more of the resolve operation, the clear operation, or the unresolve operation are executable by the processor to cause the apparatus to:
perform the resolve operation, the clear operation, or the unresolve operation on a second transaction associated with a second bin of the frame based at least in part on the identified memory address, wherein the second bin precedes the first bin.

20. An apparatus for image processing at a device, comprising:
means for identifying memory location information corresponding to a first transaction associated with a first bin of a frame;
means for performing based at least in part on the identified memory location information, one or more of a resolve operation, a clear operation, an unresolve operation, or a tag compare operation;
means for identifying depth and color information of the first transaction, wherein the resolve operation, the clear operation, the unresolve operation, or the tag compare operation is performed concurrently with the identifying of the depth and color information of the first transaction; and
means for writing the depth and color information of the first transaction based at least in part on the resolve operation, the clear operation, the unresolve operation, or the tag compare operation.
